(19) United States
(12) Patent Application Publication
(10) Pub. No.: US 2007/0124679 A1
(43) Pub. Date: May 31, 2007

(54) Video summary service apparatus and method of operating the apparatus

(75) Inventors: Jin Guk Jeong, Suwon-si (KR); Young Su Moon, Seoul (KR); Doo Sun Hwang, Seoul (KR); Ki Wan Eom, Seoul (KR); Cheol Kon Jung, Suwon-si (KR); Ji Yeuon Kim, Seoul (KR); Sang Kyun Kim, Yongin-si (KR); Hyoung Gook Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/483,847

(22) Filed: Jul. 11, 2006

(30) Foreign Application Priority Data
Nov. 28, 2005 (KR) 10-2005-0114272

(51) Int. Cl. H04N 7/16; G11B 27/00; H04N 5/44; H04N 7/173

(52) U.S. Cl. 715/723; 725/8; 725/135; 715/720

(57) ABSTRACT

The invention provides a video summary service providing apparatus and method, and more particularly, provides a video summary service providing apparatus and method in which a summary image of a video is generated by considering a resources state of a device for summarizing the video and an expected replay time used in summarizing desired by the user, and the generated summary image, prepared to be suitable for a replay time desired by the user, is provided to the user.

### CROSS-REFERENCE TO RELATED APPLICATIONS

This application claims the benefit of Korean Patent Application No. 10-2005-114272, filed on Nov. 28, 2005, in the Korean Intellectual Property Office, the disclosure of which is incorporated herein by reference.

### BACKGROUND OF THE INVENTION

1. Field of the Invention

The present invention relates to a video summary service providing apparatus and method, and more particularly, to a video summary service providing apparatus and method in which a summary image of a video is generated by considering a resources state of a device summarizing the video by using a video summary algorithm and a summary replay time desired by a user, and a summary image corresponding to a replay time desired by the user is provided to the user.

2. Description of the Related Art

Currently, in the IT business field, various video media are actively provided. Starting with new video services such as satellite Digital Multimedia Broadcasting (DMB), terrestrial DMB, data broadcasting, Internet broadcasting, and in the IT field including communications, Internet services, and digital devices, the video on demand industry rises unimpeded.

“The time of portable TV” started with the satellite/terrestrial DMB, and mobile telecom companies then started to extend video on demand service via data broadcasting of their own companies via consortiums with content companies. Also, Internet portal sites provide to users via sites of their own company and cooperation sites, homemade videos or videos secured via the consortiums with the content companies.

In addition, TV portal sites currently provided are a predecessor of Internet TV and implement a service in which users can watch movies or dramas provided by the portal sites by downloading or streaming as video on demand (VOD) via a PC, a notebook PC, and a mobile communication terminal. Following this, Triple Play Service (TPS), in which the Internet, broadcasting, and telephonic communication will pick up the pace and will be able to use the Internet network via broadband convergence networks, and the demand with respect to video contents will be increased even more.

As described above, to younger generations familiar with video culture, since video is not an optional feature but an essential feature, industries related to video are seen as the most competitive of all IT fields. Accordingly, a market of video replay terminals such as DMB terminals and Portable Multimedia Players (PMPs) is expanding day by day.

The mobile telecom companies competitively release satellite DMB phones and terrestrial DMB phones, and MP3 player companies release various models of PMPs supporting DMB. Currently, an MP3 player is also equipped with a minimal LCD as a display unit, whose size is 2 inches, thereby supporting the function of replaying a video. The various video support terminals described need to be developed into convergence products supporting all types of video services in one terminal.

As described above, due to development of video services and performance of terminals, the demand of users pursuing convenience is increasing. Namely, users do not request terminals to simply replay videos anymore but request video services supporting various additional functions.

For example, there are summary video services. Summary video services are services generating a summary image of a video, and providing the summary image to a user when the user has no time to watch an entire video of several hours. Since summary video services are suitable for everyday use by busy people watching videos via their own portable device while commuting during rush hour or on a short break, summary video services are expected to be gradually increased.

However, summary video services according to conventional technologies have a drawback of generating a summary video without considering a performance level of user terminals or user requirements. Namely, there are various terminals which may be equipped with an algorithm for summarizing a video, such as a PC, a notebook PC, a mobile communication terminal, an MP3 player, and a PMP, and services provided to each terminal also varies. Also, performance levels of most PCs are better than mobile communication terminals, and in identical terminals, performance levels of terminals in a state in which no services are currently performed is better than terminals in a state in which a service, such as a game, is performed. Accordingly, when the video summary algorithm summarizes the video in a mobile communication terminal by a same process as being performed as in a PC, a time used in summarizing may be considerably more than the PC environments.

Also, since performance of the terminal varies with a service currently performed in the terminal, there may be a difference in service performance times according to a present state of the terminal. Also, since a resource state and a performance level are different for each mobile communication terminal, there may be a difference in the performance time for each mobile communication terminal. Also, most video summary services according to conventional technologies generate a summary video according to algorithms suitable for only a certain standard without considering a taste or selection of users, thereby providing summary images which do not include an image desired by the users.

As described above, according to conventional technologies, a video is summarized without considering a performance level of a device equipped with a video summary algorithm and requirements of a user, thereby generating a problem of being difficult to adapt to a personality of each user, which a current trend is attaching great importance to. Therefore, it is required to develop a video summary service apparatus and method in which the problems of the conventional technologies are overcome and an optimal video summary algorithm is automatically constructed to be adapted to a performance level and a resources state of a device, thereby generating a summary video.

### SUMMARY OF THE INVENTION

Additional aspects and/or advantages of the invention will be set forth in part in the description which follows and, in part, will be apparent from the description, or may be learned by practice of the invention.

An aspect of the present invention provides a video summary service apparatus and method in which a summary image is generated by constructing an optimal video summary algorithm according to a performance level and a resources state of a device for summarizing the video and a replay time desired by a user, thereby acquiring an effect of generating the summary image within a replay time that the user wants by considering the performance level of the device.

An aspect of the present invention provides a video summary service apparatus and method in which a summary image is generated by setting up an event, according to a previously determined significance, according to a request of a user or a type of a video, and constructing an optimal video summary algorithm, thereby acquiring an effect of more precisely generating a summary image desired by the user according to the type of video.

According to an aspect of the present invention, there is provided a video summary service providing method of preparing a summary video of a predetermined video, the method including: maintaining a memory in which at least one video summary algorithm is stored, each of the at least one video summary algorithm including at least one event; receiving a request for generating the summary video of the predetermined video from a user and receiving an expected replay time used in generating the summary video from the user; dividing the predetermined video into at least one individual image by detecting a shot change of the video; extracting the video summary algorithm corresponding to the video from the memory; with respect to each of the at least one event included in the extracted video summary algorithm, computing a detection time used in detecting the at least one individual image in which an event occurs, from the at least one individual image, for each event; computing an event significance of each of the at least one event according to the detection time; selecting an K number of the events from the at least one event according to the event significance, the detection time, and the expected replay time; computing an individual image significance for each of the at least one individual image by using the selected K number of the events; and generating a summary image by sequentially sorting the individual images according to the computed individual image significance.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a configuration of a video summary service apparatus according to an embodiment of the present invention;

FIG. 2 is a diagram illustrating images taken from a video of a soccer game, to which an event of a soccer video summary algorithm may be applied, according to an embodiment of the present invention;

FIG. 3 is a diagram illustrating images taken from a video of a baseball game, to which an event of a baseball video summary algorithm may be applied, according to an embodiment of the present invention;

FIG. 4 is a diagram illustrating images taken from a video of a drama, to which an event of a drama video summary algorithm may be applied, according to an embodiment of the present invention;

FIG. 5 is a diagram illustrating an event significance table in which a significance of each event included in the soccer video summary algorithm is computed, according to an embodiment of the present invention;

FIG. 6 is a diagram illustrating the events of the soccer video summary algorithm, sorted in an order of the event significance, according to an embodiment of the present invention;

FIG. 7 is a diagram illustrating an event return value according to an embodiment of the present invention;

FIG. 8 is a diagram illustrating an individual image significance table in which an individual image significance computed corresponding to each of at least one individual image included in the video of a soccer game is recorded, according to an embodiment of the present invention;

FIG. 9 is a flowchart illustrating a method of providing a video summary service, according to an embodiment of the present invention;

FIG. 10 is a diagram illustrating individual images of a video of a drama, according to an embodiment of the present invention;

FIG. 11 is a diagram illustrating an event significance table of a video of a drama, according to an embodiment of the present invention;

FIG. 12 is a diagram illustrating an event return value table of a video of a drama, according to an embodiment of the present invention;

FIG. 13 is a diagram illustrating an individual image significance table of a video of a drama, according to an embodiment of the present invention;

FIG. 14 is a diagram illustrating images taken from summary images of the video of a drama, generated according to an embodiment of the present invention; and

FIG. 15 is a block diagram illustrating an inner configuration of a general use computer system capable of being employed to embody the method of providing a video summary service, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

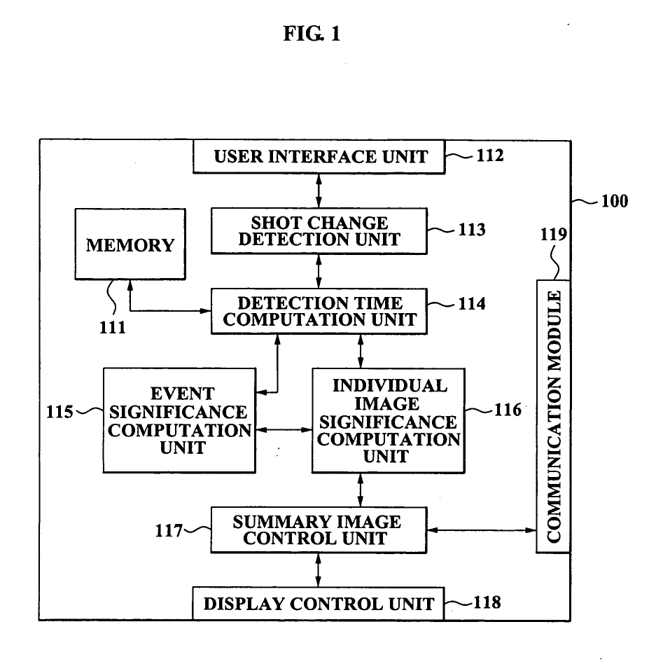

FIG. 1 is a block diagram illustrating a configuration of a video summary service apparatus 100 according to an embodiment of the present invention.

The video summary service apparatus 100 may be embodied as one of a personal video recorder (PVR), a home server, a smart mobile server, a DVD player/recorder, a PC, a notebook PC, a PDA, and a mobile communication terminal.

The video summary service apparatus 100 may include a memory 111, a user interface unit 112, a shot change detection unit 113, a detection time computation unit 114, an event significance computation unit 115, an individual image significance computation unit 116, a summary image control unit 117, a display control unit 118, and a communication module 119.

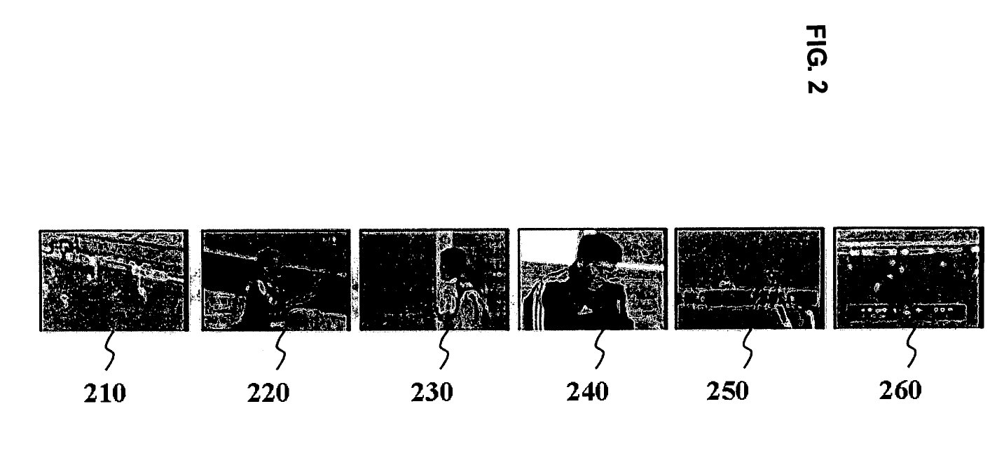

In the memory 111, at least one video summary algorithm is stored. Each of the video summary algorithms includes at least one event. The video summary algorithm may include at least one event, each event different according to a type of video. A type of an event may be previously determined according to the type of video or an input by a user but not limited thereto. The event included in the video summary algorithm according to the type of video will be described in detail with reference to each embodiment illustrated in FIGS. 2 through 4.

FIG. 2 is a diagram illustrating images taken from a video of a soccer game, to which an event of a soccer video summary algorithm may be applied, according to an embodiment of the present invention.

As shown in FIG. 2, the video of a soccer game may include events according to various types of images capable of occurring in a real soccer game. For example, as images generally occurring in the video of a soccer game, there are images of score captions, images of motions in scoring a goal, images of motions in shooting, images of a penalty area, images of close-ups, images of replays, images during whistle sound occurring, and images during a heightening of cheers of a crowd or voice of an announcer.

The arranged soccer video images may generally be images in which a main event of a soccer game occurs. Accordingly, the soccer video summary algorithm may include an event including content occurring in each image. Namely, the soccer video summary algorithm may set up “score caption” recognition, keywords, for example, “goal” or “shoot” recognition, “penalty area” detection, “close-up” detection, “replay scene” detection, “whistle sound” detection, and/or “a heightening crescendo level of audio” detection.

As shown in FIG. 2, a first scene 210 is a scene to which the event such as “penalty area” detection or “goal” keyword recognition may be applied. A second scene 220, a third scene 230, and a fourth scene 240 are scenes to which the event of “close-up” detection may be applied. A fifth scene 250 is a scene to which the event of “replay scene” detection may be applied. A sixth scene 260 is a scene to which the event of “score caption” recognition may be applied.

The described types of events may be previously set up by a manufacturer of the video summary algorithm or may be set up by a user. The events included in the video summary algorithm may be set up according to a type of video to which the video summary algorithm is applied.

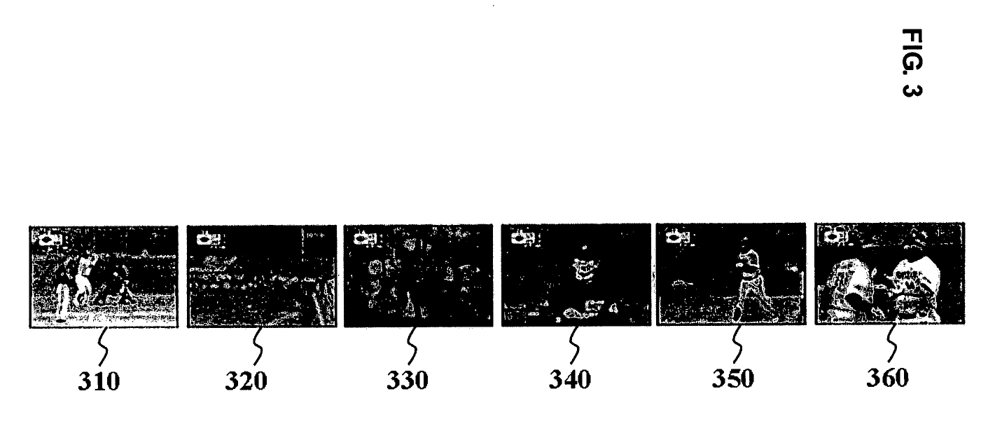

FIG. 3 is a diagram illustrating images taken from a video of a baseball game, to which an event of a baseball video summary algorithm may be applied, according to an embodiment of the present invention.

In the case of the baseball video shown in FIG. 3, the video summary algorithm may include events such as “score/count change” detection, “out count caption” recognition, keyword, for example, “homerun” or “hit” recognition, “close-up” detection, “pitch view” detection, and/or “a heightening crescendo level of audio”. As described above, the events included in the baseball video summary algorithm may be set up as an important scene heightening interest in a spectator.

As shown in FIG. 3, a first scene 310 is a scene to which the event of “pitch view detection” may be applied. A second scene 320 is a scene to which the event of “homerun” keyword recognition may be applied. A third scene 330, a fourth scene 340, and a sixth scene 360 are scenes to which the event of “close-up” detection may be applied. A fifth scene 350 is a scene to which the event of “score/count change” detection may be applied.

As described above, the video summary algorithm according to an embodiment of the present invention may be applied to not only a broadcasted sports video but also a drama or movie video, but is not limited thereto.

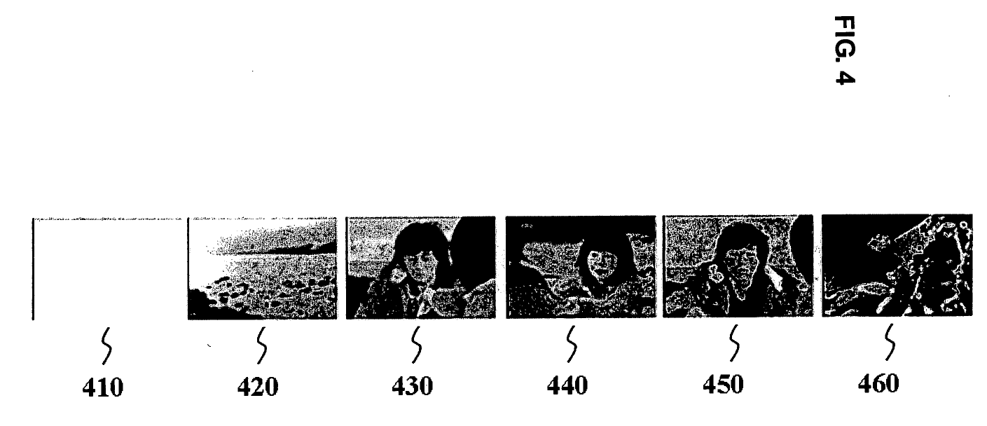

FIG. 4 is a diagram illustrating images taken from a video of a drama, to which an event of a drama video summary algorithm may be applied, according to an embodiment of the present invention.

In the case of the video of a drama, the video summary algorithm may include “face” recognition”, “head scene” recognition, “music section” detection, “close-up” detection, “fade in/out” detection, and “action scene” detection. A first scene 410 is a scene to which the event of “fade in/out” detection may be applied. A second scene 420 and a sixth scene 460 are scenes to which the event of “music section” detection may be applied. A third scene 430, a fourth scene 440, and a fifth scene 450 are scenes to which the event of “head scene” recognition may be applied.

As described above, the events included in the drama video summary algorithm may be generally set up as a scene heightening interest in a drama viewer. In the case of a drama video, events which differ from each other according to a type of drama may be included and a method of forming the video summary algorithm by setting up the type of event according to selection of the user may be embodied.

Referring to FIG. 1, to record the at least one video summary algorithm, the memory 111 may be constructed of a memory such as a Universal Serial Bus (USB) memory, a CompactFlash (CF) memory, a Secure Digital (SD) memory, a mini SD (miniSD) memory, an extreme digital (XD) memory, a Memory Stick, a Memory Stick Duo, a SmartMedia Card (SMC) memory, a Multi Media Card (MMC) memory, and/or a Reduced Size MMC (RS-MMC) memory and/or may be constructed as a hard disk used in a general PC or a notebook PC. Also, the memory 111 may be an embedded type included in an internal configuration of the video summary service apparatus 100 and/or an external type installed outside of the video summary service apparatus 100. The memory 111 may support not only the aforementioned memory types but also all memory types which may be developed in the future, such as phase-change random access memory (PRAM), ferroelectric random access memory (FRAM), and/or magnetic random access memory (MRAM).

The user interface unit 112 receives a request for generating a summary image of a predetermined video from the user and receives an expected replay time used in generating the summary image from the user. Namely, the user selects the video whose summary image is desired to be generated and inputs an expected replay time used in summarizing the video, via the user interface unit 112. The meaning of the expected replay time will be described later with reference to an operation of the event significance computation unit 115.

The shot change detection unit 113 detects a shot change in the video and divides the video into at least one individual image. Generally, a video may be a number of still pictures, namely, frames. One shot may be formed of frames with similar contents. For example, the frames filmed by one filming apparatus may be set up as one shot. For example, in the video, when there is no great shift in a camera view for 10 seconds in which certain characters are shown, the frames replayed within those 10 seconds may be set up as one shot, namely, an individual image.

As described above, the shot change detection unit 113 divides the video into at least one individual image. The detection of the shot change may be embodied by a predetermined shot change detection algorithm generally used in the art. Accordingly, the shot change detection unit 113 may include the shot change detection algorithm.

The individual image includes at least one key frame. The key frame may be embodied as a frame representing a relevant individual image. A method of setting up the key frame may be embodied by including all various methods generally used in the art, according to the shot change detection algorithm.

The detection time computation unit 114 extracts the video summary algorithm corresponding to the video from the memory 111 and computes a detection time used in detecting an individual image in which the event occurs from the at least one individual image, with respect to each of the at least one event included in the extracted video summary algorithm, for each event.

When the user selects a video, whose summary image is desired to be generated, via the user interface unit 112, the detection time computation unit 114 extracts the video summary algorithm corresponding to the selected video from the memory 111. Namely, when the video is a video of a soccer game, the soccer video summary algorithm is extracted, and when the video is a video of a drama, the drama video summary algorithm is extracted.

The detection time computation unit 114 computes a detection time corresponding to each of the at least one event included in the extracted video summary algorithm. The detection time indicates a time used in detecting an individual image in which a certain event occurs in the video according to the video summary algorithm. For example, in the case of the soccer video summary algorithm, the detection time computation unit 114 may extract an individual image in which the event of “close-up” detection occurs from the events included in the soccer video summary algorithm, from the video. In this case, the time used in detecting the individual image in which the event of “close-up” detection occurs from the video may be the detection time.

The detection time may be determined according to a performance level or a state of resources of a video summary service apparatus equipped with the video summary algorithm. Also, the detection time may be determined by multiplying a time used in processing a frame by the video summary service apparatus according to the performance level or the state of resources by a number of the individual images.

For example, when the video summary service apparatus has specifications of a 2.8 GHz CPU, 512 MB memory, and 7200 rpm HDD and a current utilization rate of the CPU of 10% and an amount of 420 MB of used memory, a time used in processing one frame by applying a predetermined algorithm of “close-up” detection by the video summary service apparatus may be computed to be 106 ms. The detection time may be previously computed via a predetermined experiment or may be computed by executing an actual algorithm with respect to one frame.

In the example, when the video includes 300 individual images, the video has 300 key frames. Accordingly, the detection time of the event of “close-up” may be computed as 106 ms*300=31800 ms. Namely, the detection time computation unit 114 may compute the detection time by computing a time used in determining whether the event is applied to the key frame of each of the individual images. The detection time computation unit 114 may compute the detection time with respect to all occurrences of each event included in the video summary algorithm.

The event significance computation unit 115 computes event significance according to the computed detection time with respect to each of the events and selects K events from the at least one event according to the event significance, the detection time, and the expected replay time.

The event significance computation unit 115 computes a significance of each of the events according to the computed detection time of each of the events. The event significance may be computed via Equation 1 below.
P=C*I*F(Tg−T)/Tg Equation (1)

In this case, F(X)=0 when X is not greater than 0, and F(X)=X when X is greater than 0. In Equation 1, P indicates the event significance, C indicates the event confidence, I indicates the event importance level, T_{g} indicates an expected replay time, and T indicates a detection time.

As shown in Equation 1, the event significance may be computed according to the event confidence, the event importance level, the expected replay time, and the detection time. The event confidence indicates a precision of each of the event detection algorithms. For example, in the case of the “close-up” detection algorithm, since detection performance of the algorithm is high, a confidence of a result of the algorithm may be determined to be high. However, in the case of keyword recognition algorithm, since the detection performance of the algorithm is low, the confidence of a result of the algorithm may be determined to be low. Namely, the result of the algorithm whose detection performance is high may be more reliable than the result of the algorithm whose detection performance is low. The event confidence may be set up at a point where RECALL of the video is identical with PRECISION of the video, via a predetermined experiment. The event confidence may be set up as a predetermined value via the experiment.

The event importance level indicates a relative importance level with respect to each event included in the video summary algorithm including the event. For example, in the case of the soccer video summary algorithm, “score caption” recognition, keyword, for example, “goal” or “shoot” recognition, “penalty area” detection, “close-up” detection, “replay scene” detection, “whistle sound” detection, and “a heightening crescendo level of audio” detection may be set up as the event.

In this case, a level may be set up according to the relative importance level of each of the events. For example, an importance level of 0.9 may be given to the event of keyword, for example, “goal” or “shoot” recognition. Also, an importance level of 0.8 may be given to the event of “score caption” recognition, an importance level of 0.6 may be given to the event of “replay scene” detection, an importance level of 0.5 may be given to the events of “close-up” detection and “a heightening crescendo level of audio” detection, an importance level of 0.4 may be given to the event of “penalty area” detection, and an importance level of 0.3 may be given to the event of “whistle sound” detection.

As described above, in the case of the event of keyword recognition, since a position of a scene of a goal or a shoot, which is an important action in a soccer game, may only be precisely known by the event, an importance level higher than other events may be given. Also, in the case of the event of “score caption” recognition, since to determine a precise position of the scene of goal is difficult but it may be determined that the scene of goal exists before the score is changed, an importance level higher than the event of “close-up” detection or “a heightening crescendo level of audio” detection may be given. However, in the case of the event of “whistle sound” detection, since a previous scene cannot be known by only a sound of a whistle, an importance level lower than other events may be given. The importance level is a previously determined value given to each of the events and may be maintained by the event significance computation unit 115.

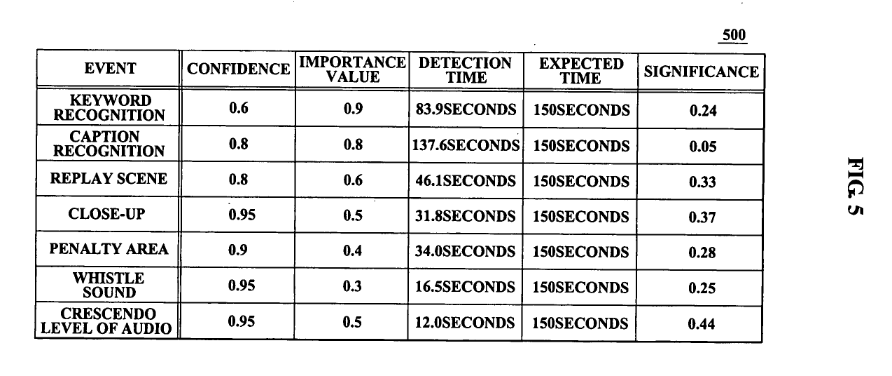

As described above, the event significance computation unit 115 may compute a significance for each event by using the event confidence and the event significance. This will be described in detail with reference to FIG. 5.

FIG. 5 is a diagram illustrating an event significance table 500 in which a significance of each event included in the soccer video summary algorithm is computed, according to an embodiment of the present invention.

The event significance computation unit 115 may compute the significance of each of the events by using an event confidence, an event importance level, a detection time, and/or an expected replay time. The event significance table 500 illustrated in FIG. 5 includes an event significance computed with respect to each of the events included in the soccer video summary algorithm.

As shown in FIG. 5, the significance of the event of keyword recognition included in the soccer video summary algorithm may be computed as 0.24. Also, the significance of the event of caption recognition may be computed as 0.05, the significance of the event of replay scene may be computed as 0.33, the significance of the event of close-up may be computed as 0.37, the significance of the event of penalty area may be computed as 0.28, the significance of the event of whistle sound may be computed as 0.25, and the significance of the event of a crescendo level of audio may be computed as 0.44, for example. The significance of each of the events may be computed by Equation 1.

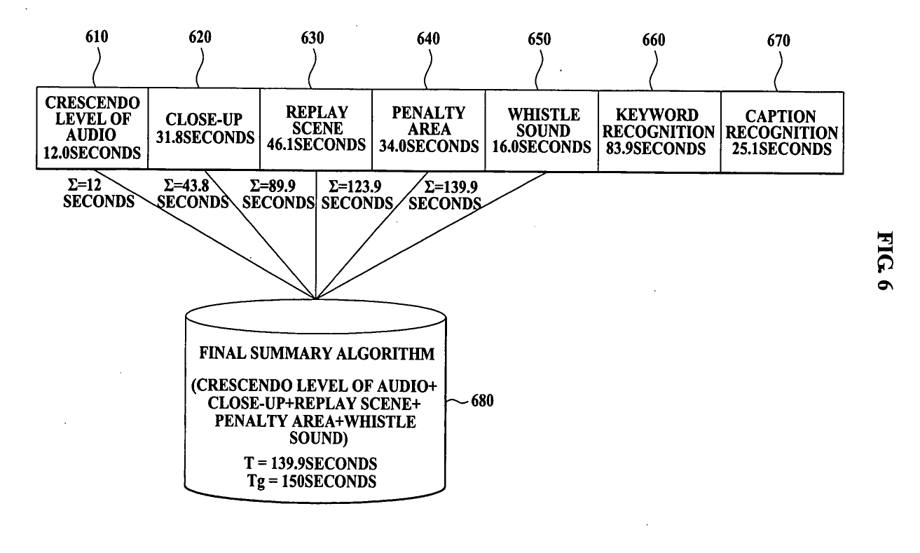

Referring to FIG. 1, when the significance of each of the events is computed, the event significance computation unit 115 sorts the at least one event in an order of high significance. The event significance computation unit 115 selects K events from the sorted events with reference to the expected replay time inputted by the user. The selection of the event will be described in detail with reference to FIG. 6.

FIG. 6 is a diagram illustrating the events of the soccer video summary algorithm, sorted in an order of the event significance, according to an embodiment of the present invention. The event sorting illustrated in FIG. 6 may be set up being coupled with the event significance table 500 of FIG. 5.

As shown in FIG. 6, the event significance computation unit 115 may sort the events in an order of a crescendo level of audio 610, a close-up detection 620, a replay scene 630, a penalty area 640, a whistle sound 650, a keyword recognition 660, and/or a caption recognition 670, according to the order of high event significance in the event significance table 500.

The event significance computation unit 115 adds a detection time of each of the events according to the sorted order and compares the detection time with the expected replay time. As a result of the comparison, when the detection time of which a detection time of a first event to a detection time of a K+1th event are added is more than the expected replay time, the event significance computation unit 115 selects the first event through a Kth event.

Referring to FIG. 6, the event significance computation unit 115 adds the detection time for each event according to the sorted order. The detection time for each event is identical with the detection time illustrated in the event significance table of FIG. 5.

Namely, the event significance computation unit 115 adds 12.0 seconds that is a detection time of the crescendo level of audio event 610 to 31.8 seconds that is a detection time of the close-up event 620 and compares a result of adding the detection times with 150 seconds that is an expected replay time inputted by the user. Since the result of adding the detection times is less than the expected replay time, the event significance computation unit 115 continuously adds a subsequent event detection time.

As a result of the addition, since a detection time to which the detection time of the crescendo level of audio event 610 to a detection time of the whistle sound event 650 are added is 139.9 seconds, and a detection time to which the detection time of the crescendo level of audio event 610 to a detection time of the keyword recognition event 660 are added is 223.8, the event significance computation unit 115 determines the detection time value to which the detection time of the crescendo level of audio event 610 to the detection time of the whistle sound event 650 are added, which is less than 150 seconds that is the expected replay time, to be a valid detection time. Accordingly, the event significance computation unit 115 may select the crescendo level of audio 610, the close-up event 620, the replay scene event 630, the penalty area event 640, and the whistle sound event, as a final summary algorithm 680.

According to the operation of the event significance computation unit 115, a video summary algorithm may be constructed by selecting an event to generate a summary image with respect to a predetermined video by considering a performance level and a state of resources of a video summary service apparatus and an expected replay time of a user. Namely, an optimal video summary algorithm corresponding to the performance level and the present state of resources of the apparatus equipped with the video summary algorithm and the expected replay time of the user may be constructed.

Referring to FIG. 1, as described above, when the optimal video summary algorithm corresponds to each environment, the individual image significance computation unit computes an individual image significance with respect to the at least one individual image by using K events selected by the event significance computation unit 115. The individual image significance computation unit 116 may compute the individual image significance via Equation 2.
Q=ΣWi*Ci Equation (2)

In this case, Q indicates individual image significance, Wᵢ indicates an i-th event weight, and Cᵢ indicates an i-th event return value.

As shown in Equation 2, the individual image significance computation unit 116 may compute a significance of the individual image by adding up weights and return values of the K events selected by the event significance computation unit 115, with respect to one individual image.

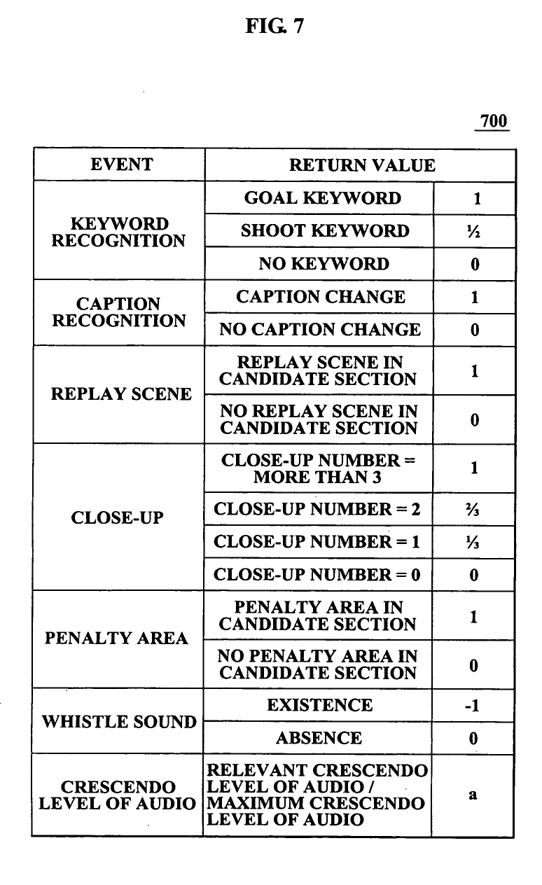

To compute the significance of the individual image, the memory 111 may maintain an event return value table in which an event return value corresponding to each of the events included in each of the video summary algorithms. The event return value table will be described with reference to FIG. 7.

FIG. 7 is a diagram illustrating event return values according to an embodiment of the present invention.

The event return value indicates a set value with respect to a plurality of sub-events capable of being included in the event. For example, as shown in FIG. 7, in the case of the keyword recognition event, there may be a sub-event such as a keyword of a goal or shoot. Since the goal event is of higher interest to the user than the shoot event in a soccer game, the goal keyword sub-event may be set up as 1 and the shoot keyword sub-event may be set up as ½. Also, when there is no keyword, it may be set up as 0 for event return value. As described above, the event return value according to the sub-event may be set up in the event. The event return value may be determined by the user or preset at a factory.

Referring to FIG. 1, the individual image significance computation unit 116 computes a relative value corresponding to each of the K events selected by the event significance computation unit 115. The relative value of the event may be set up according to a general relative significance with respect to each of the events capable of occurring in the video. For example, in the case of the soccer video, when the penalty area event and the whistle sound event are selected by the event significance computation unit 115, since a goal or a shoot, which is most important, generally occurs in the penalty area, the penalty area event may be set up to be a relatively higher value than the whistle sound.

Also, the individual image significance computation unit 116 receives preference event information with respect to the video from the user via the user interface unit 112. The preference event information may be set up to be a relative value with respect to the event preferred by the user. For example, in the case of a movie video, when the user prefers to see only action scenes by fast forward function, preference event information with respect to an action scene detection event may be utilized.

The individual image significance computation unit 116 computes a weight with respect to each of the K events by using the event relative value or the preference event information.

The individual image significance computation unit 116 computes a second value corresponding to each of the events by multiplying the event return value corresponding to each of the events by the event weight, from the K events, and computes individual image significance with respect to the individual image by adding the K second values corresponding to the K events, with respect to one individual image. The individual image significance computation may be embodied via Equation 2.

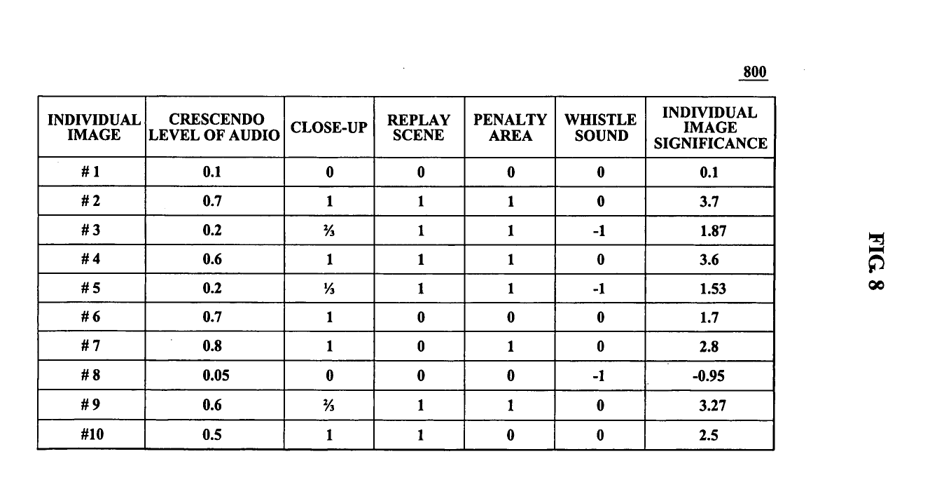

FIG. 8 is a diagram illustrating an individual image significance table 800 in which individual image significance computed corresponding to each of the at least one individual image included in the video of a soccer game is recorded, according to an embodiment of the present invention.

As shown in FIG. 8, when a soccer video includes 10 individual images, the individual image significance computation unit 116 may compute individual image significance via Equation 2, according to each of the individual images.

As described above, when the individual image significance is computed, the summary image control unit 117 generates a summary image by sequentially sorting each of the individual images according to an order of the individual image significance. In generating the summary image, when an expected replay time is received from the user via the user interface unit 112, the summary image control unit 117 may generate the summary image by extracting an individual image according to the expected replay time from the sorted summary image.

For example, as shown in FIG. 8, the summary image generation unit 117 may sort the individual images, in an order of an individual image #2, an individual image #4, an individual image #9, an individual image #7, an individual image #10, an individual image #3, an individual image #6, an individual image #5, an individual image #1, and an individual image #8, according to an individual image significance order. In this case, when the expected replay time inputted from the user is 10 minutes, the aggregation of individual images corresponding to a replay time of up to 10 minutes, such as the individual image #2 and the individual image #4, may be selected by considering the replay time of the individual image, to generate the summary image.

Also, the summary image control unit 117 transmits the generated summary image to the display control unit 118, and the display control unit 118 may control a predetermined display unit so that the summary image is replayed via the display unit.

Also, the summary image control unit 117 may transmit the generated summary image to a predetermined replay device, terminal, or server via the communication module 119. To transmit the summary image, the communication module 119 may include a short-range communication module for performing short-range communication, such as with Wireless LAN (WLAN), Bluetooth, Ultra-wideband (UWB), Infrared Data Association (IrDA), Home Phoneline Networking Alliance (HPNA), Shared Wireless Access Protocol (SWAP), and Institute of Electrical and Electronics Engineers standard 1394 (IEEE1394). Also, the communication module may support at least one of public switched telephone network (PSTN), Code Division Multiple Access (CDMA), Wideband CDMA (WCDMA), all IP, Global System for Mobile Communication (GSM), General Packet Radio Service (GPRS), and existing access methods related to mobile communication and may be embodied to support at least one protocol of call control protocols for accessing Voice over Internet Protocol (VoIP) call such as H.323, Message Gateway Control Protocol (MGCP), Session Initiation Protocol (SIP), or Megaco.

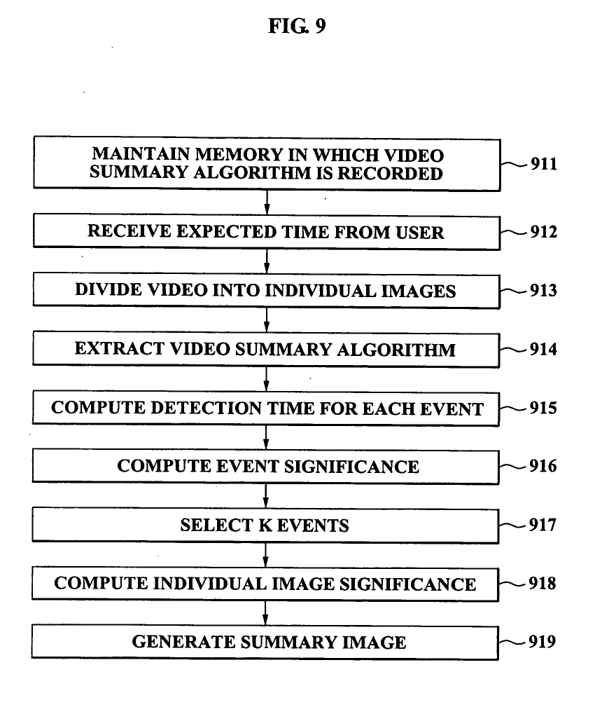

In the aforementioned, with reference to FIGS. 1 through 8, the video summary generation method performed by the configuration and the operation of the video summary service apparatus according to an embodiment of the present invention has been described, predominately with a soccer video as an example. Hereinafter, with reference to FIGS. 9 through 14, a video summary service providing method according to an embodiment of the present invention will be described in greater detail, with a drama video as an example.

FIG. 9 is a flowchart illustrating a method of providing a video summary service, according to an embodiment of the present invention.

According to an embodiment of the present invention, the video summary service apparatus maintains a memory in which at least one video summary algorithm is stored (operation 911). Each of the video summary algorithms includes at least one event. The video summary service apparatus receives a request for generating a summary image with respect to a predetermined video from the user and receives an expected replay time used in generating the summary image from the user (operation 912). The video summary service apparatus then detects a shot change of the video and divides the video into at least one individual image (operation 913).

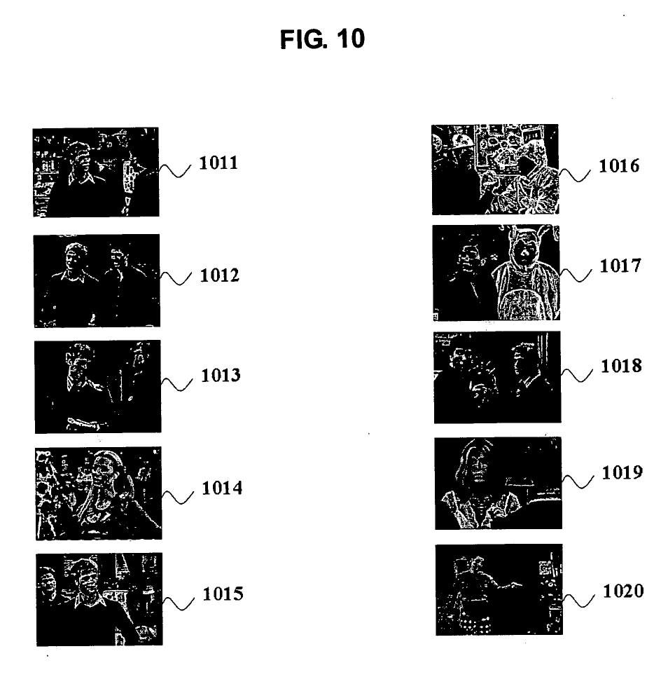

In operation 913, when the video requested by the user is a drama video, the drama video may be divided into a first individual image 1011 through a tenth individual image 1020, as shown in FIG. 10. A frame of each of the individual images shown in FIG. 10 may set up as a key frame representing each of the individual images.

After 913, the video summary service apparatus extracts a drama video summary algorithm corresponding to the drama video from the memory (operation 914). The drama video summary algorithm may include a keyword recognition event, a face recognition event, a fade in/out event, a close-up event, a music section event, and/or an action scene event, but is not limited thereto.

With respect to each of the events included in the extracted video summary algorithm, the video summary service apparatus computes a detection time used in detecting an individual image in which an event occurs from the first individual image 1011 through the tenth individual image 1020, for each event (operation 915).

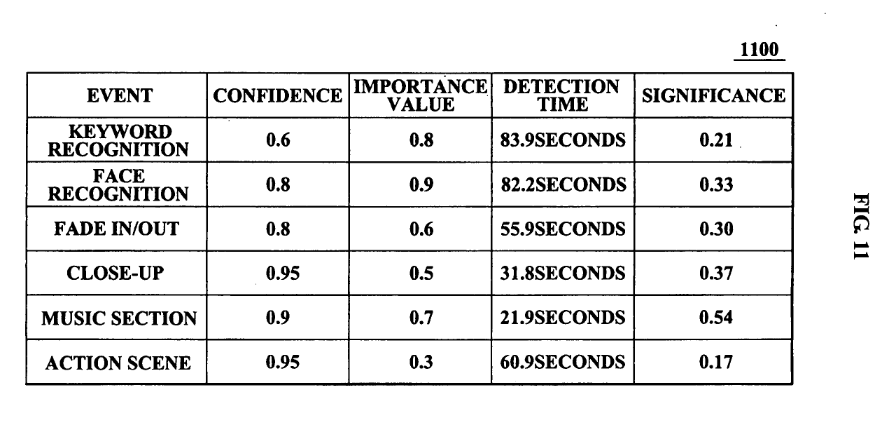

When the detection time for each event is computed, the video summary service apparatus computes an event significance according to the detection time with respect to each of the events via Equation 1 (operation 916). As an event significance table 1100 shown in FIG. 11, the video summary service apparatus may compute 0.21 as the significance of the keyword recognition event, 0.33 as the significance of the face recognition event, 0.30 as the significance of the fade in/out event, 0.37 as the significance of the close-up event, 0.54 as the significance of the music section event, and 0.17 as the significance of the action scene event.

As described above, when the event significance of each of the events is computed, the video summary service apparatus selects K events from all occurrences of each event included in the drama video summary algorithm by considering the event significance, the detection time, and the expected replay time (operation 917). Namely, referring to the event significance table 1100, when the expected replay time inputted by the user is 150 seconds, a final video summary algorithm may be constructed by selecting the music section event, the close-up event, and the face recognition event whose total amount of the detection times is less than the 150 seconds, from the events sorted in the order of the event significance.

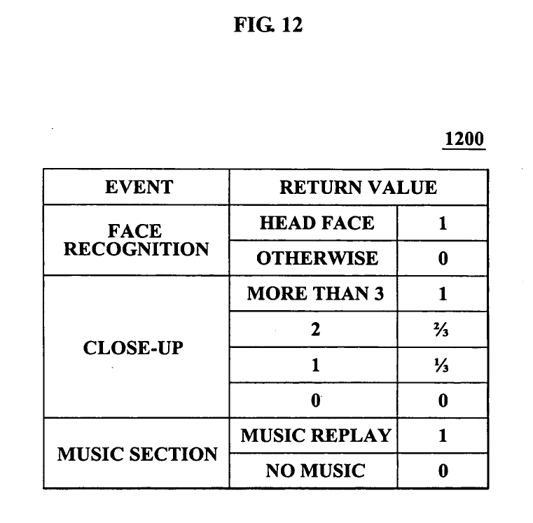

As described above, when the final video summary algorithm is constructed by selecting the three events, the video summary service apparatus computes an individual image significance with respect to each of the first individual image 1011 through the tenth individual image 1020 by using the three events (operation 918). The video summary service apparatus may compute the individual image significance by substituting an event weight set up according to a return value and a value inputted by the user of each of the events recorded in an event return value table 1200 shown in FIG. 12 for Equation 2.

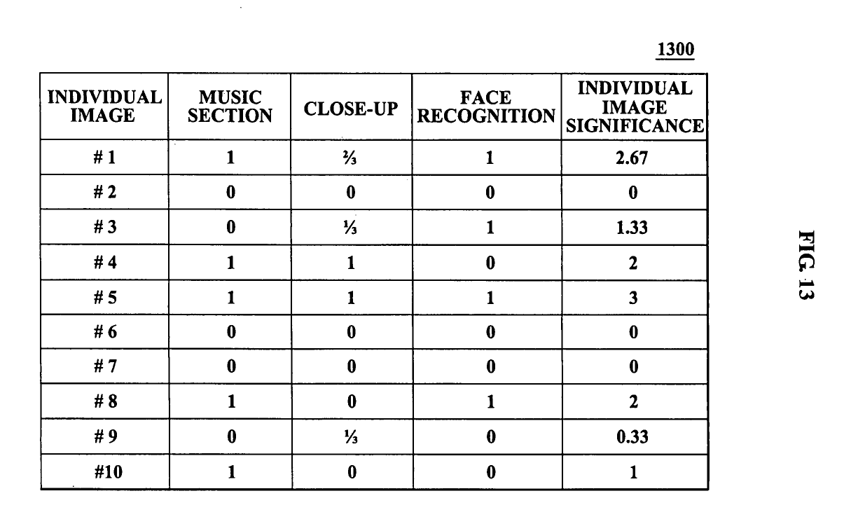

As shown in FIG. 13, when the individual image significance with respect to each of the first individual image 1011 through the tenth individual image 1020 is computed, the video summary service apparatus generates a summary image by sorting each individual image according to an order of the computed individual image significance (operation 919). In this case, when an expected replay time of the summary image is inputted from the user, the summary image may be generated by extracting only the individual images, whose aggregated replay time is less than the expected replay time, from the sorted individual image.

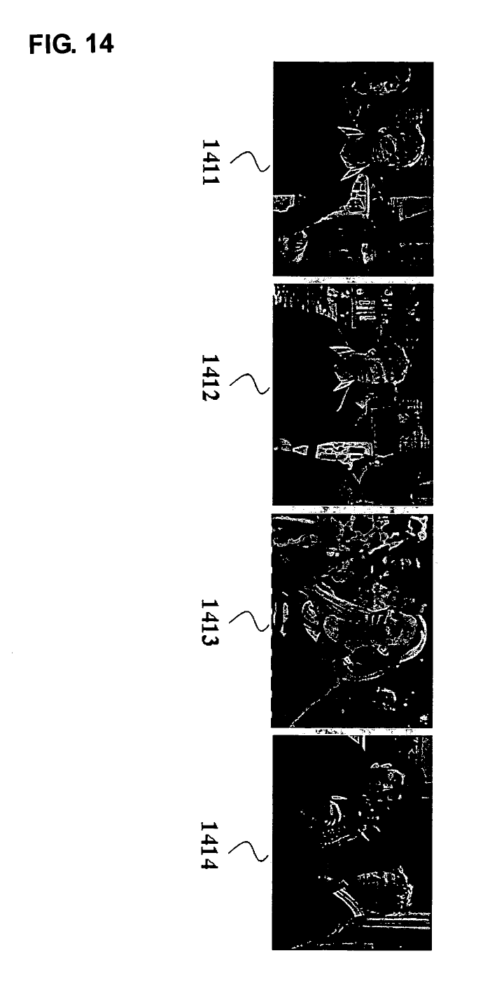

FIG. 14 is a diagram illustrating images taken from summary images of the video of a drama, generated according to an embodiment of the present invention.

The summary images shown in FIG. 14 are generated from the drama video shown in FIG. 10. Namely, from the individual images shown in FIG. 10, according to the event significance and the individual image significance computed by the video summary service apparatus, the fifth individual image 1015, the first individual image 1011, the fourth individual image 1014, and the eighth individual image 1018 are set up as a first summary image 1411, a second summary image 1412, a third summary image, 1413, and a fourth summary image 1414, respectively, thereby constructing the summary images.

As described above, according to the video summary service providing method, by considering a performance level and a resources state of an apparatus, within a replay time that the user wants, a summary image whose replay time is desired by the user may be precisely and quickly generated to be suitable for a preference of the user.

The video summary service providing method according to the present invention may be embodied as a program instruction capable of being executed via various computer units and may be recorded in a computer readable recording medium. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of this invention.

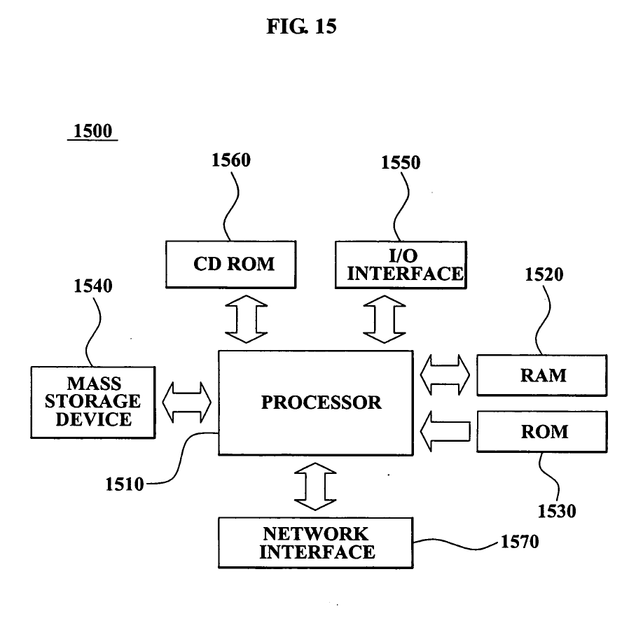

FIG. 15 is a block diagram illustrating an inner configuration of a general use computer system 1500 capable of being employed to embody the method of providing a video summary service, according to an embodiment of the present invention.

The computer system 1500 includes at least one processor 1510 connected to a main memory device including a RAM (Random Access Memory) 1520 and a ROM (Read Only Memory) 1530. The processor 1510 is also called as a central processing unit CPU. The ROM 1530 unidirectionally transmits data and instructions to the CPU, and the RAM 1520 is generally used for bidirectionally transmitting data and instructions. The RAM 1520 and the ROM 1530 may include a certain proper form of a computer readable recording medium. A mass storage device 1540 is bidirectionally connected to the processor 1510 to provide additional data storage capacity and may be one of the computer readable recording medium. The mass storage device 1540 is used for storing programs and data and is an auxiliary memory. A particular mass storage device such as a CD ROM 1560 may be used. The processor 1510 is connected to at least one input/output interface 1550 such as a video monitor, a track ball, a mouse, a keyboard, a microphone, a touch-screen type display, a card reader, a magnetic or paper tape reader, a voice or hand-writing recognizer, a joystick, and other known computer input/output unit. The processor 1510 may be connected to a wired or wireless communication network via a network interface 1570. The procedure of the described method can be performed via the network connection. The described devices and tools are well-known to those skilled in the art of computer hardware and software.

According to the video summary service apparatus and method of the present invention, a summary image is generated by constructing an optimal video summary algorithm according to a performance level and a resources state of a device for summarizing the video and a replay time desired by a user, thereby acquiring an effect of generating the summary image within a replay time that the user wants by considering the performance level of the device.

According to the video summary service apparatus and method of the present invention, a summary image is generated by setting up an event, according to a previously determined significance, according to a request of a user or a type of a video, and constructing an optimal video summary algorithm, thereby acquiring an effect of more precisely generating a summary image desired by the user according to the type of video.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A video summary service providing method of preparing a summary video of a video, the method comprising:
dividing the video into at least one individual image by detecting a shot change of the video;
computing a detection time used in detecting the at least one individual image in which an event occurs, from the at least one individual image, for each event using at least a video summary algorithm;
computing an event significance of each of the at least one event according to the detection time;
selecting a K number of the events from the at least one event according to the event significance, the detection time, and/or the expected replay time;
computing an individual image significance for each of the at least one individual image by using the selected K number of the events, wherein K is a positive integer and;
generating a summary image the individual images according to the computed individual image significance.

2. The method of claim 1, wherein at least the one video summary algorithm is stored in a memory.

3. The method of claim 1, further comprises
inputting an expected replay time used in generating the summary video from a user.

4. The method of claim 1, wherein:
the at least one individual image includes a key frame; and
in the computing a detection time used in detecting the individual image in which an event occurs from the at least one individual image, the detection time is computed by computing a time used in detecting whether the each event occurs in each of the key frame.

5. The method of claim 4, wherein the computing a detection time used in detecting the individual image in which an event occurs from the at least one individual image comprises:
detecting resources of a summary video generation apparatus replaying the video;
detecting the time used in detecting whether one event occurs in one frame by the summary video generation apparatus according to the resource; and
computing the detection time by multiplying a total number of the key frames by the computed time used in detecting whether the each event occurs in each of the key frame.

6. The method of claim 1, wherein:
the at least one video summary algorithm includes an event confidence level and an event importance level with respect to each of the at least one event; and
in the computing an event significance according to the detection time, with respect to the each event:
a first value is computed by dividing a value, computed by subtracting the detection time from the expected replay time, by the expected replay time; and
the event significance is computed by multiplying the first value by the event confidence level and the event importance level.

7. The method of claim 6, wherein, when the expected replay time is not more than the detection time, the first value is set to 0.

8. The method of claim 1, wherein the selecting aK number of the at least one event according to the event significance, the detection time, and the expected replay time comprises:
sequentially sorting the at least one event according to an order of high event significance;
adding the detection time of the each event according to the sorted order to be compared with the expected replay time; and
as a result of the comparing, when the detection times computed by adding to a K+1th event is more than the expected replay time, selecting the events up through a Kth event.

9. The method of claim 1, further comprising:
maintaining a memory in which an event return value table including an event return value corresponding to the each event included in the each video summary algorithm is stored;
computing a relative value for each of the selected K number of events;
receiving preference event information with respect to the video from the user; and
computing a weight of the each event by using one of the relative value of the event and the preference event information, and
in the computing an individual image significance for each of the at least one individual image by using the selected K number of the events, with respect to one individual image,
a second value corresponding to the each event is computed by multiplying the event return value corresponding to the each event by an event weight from the K number of the events; and
the individual image significance with respect to the individual image is computed by adding up the second value corresponding to the each of the K number of the events.

10. The method of claim 1, wherein the generating a summary image by sequentially sorting the individual images according to the computed individual image significance comprises:
receiving an expected replay time with respect to the summary image from the user;
extracting the summary image corresponding to the expected replay time from the sorted individual images; and
replaying the extracted summary image via a predetermined display.

11. The method of claim 1, wherein:
the video and the summary image are replayed or recorded via a predetermined video summary service apparatus; and
the video summary service apparatus is one of personal video recorder, a home server, a smart mobile server, a DVD player/recorder, a PC, a notebook PC, a PDA, and a mobile communication terminal.

12. A computer-readable recording medium encoded with processing instructions for causing a processor to execute a video summary service providing method of preparing a summary video of a predetermined video, the method comprising:
maintaining a memory in which at least one video summary algorithm is stored, each of the at least one video summary algorithm including at least one event;
receiving a request for generating the summary video of the predetermined video from a user and receiving an expected replay time used in generating the summary video from the user;
dividing the predetermined video into at least one individual image by detecting a shot change of the video;
extracting the video summary algorithm corresponding to the video from the memory;
with respect to each of the at least one event included in the extracted video summary algorithm, computing a detection time used in detecting the at least one individual image in which an event occurs from the at least one individual image, for each event;
computing an event significance of each of the at least one event according to the detection time;
selecting a K number of the events from the at least one event according to the event significance, the detection time, and the expected replay time, wherein K is a positive integer;
computing an individual image significance for each of the at least one individual image by using the selected K number of the events; and
generating a summary image by sequentially sorting the individual images according to the computed individual image significance.

13. A video summary service apparatus for preparing a summary video of a video, comprising:
a shot change detection unit dividing the video into at least one individual image by detecting a shot change of the video;
a detection time computation unit computing a detection time used in detecting the at least one individual image in which an event occurs, from the at least one individual image, for each event by using a video summary algorithm which includes at least one event;
an event significance computation unit computing event significance of each of the at least one event according to the detection time and selecting a K number of the events from the at least one event according to the event significance, the detection time, and/or the expected replay time wherein K is positive integer;
an individual image significance computation unit computing an individual image significance of each of the at least one individual image by using the selected K number of the events; and
a summary image control unit generating a summary image.

14. The video summary service of claim 13, wherein the video summary algorithm is stored in a memory.

15. The video summary service of claim 13, the summary image is sequentially generated by individual image significance.

16. The video summary service of claim 14, wherein the memory is one of an Universal Serial Bus (USB) memory, a CompactFlash (CF) memory, a Secure Digital (SD) memory, a mini SD (miniSD) memory, an extreme digital (XD) memory, a Memory Stick, a Memory Stick Duo, a SmartMedia Card (SMC) memory, a Multi Media Card (MMC) memory, and/or a Reduced Size MMC (RS-MMC) memory

17. The video summary service of claim 14, the expected replay time is input by a user.
